(19) United States
(12) Patent Application Publication
(10) Pub. No.: US 2009/0162062 A1
(43) Pub. Date: Jun. 25, 2009

(54) Session initiation protocol (SIP) provisioning error detection for an optical network terminal (ONT)

(76) Inventors: David A. DeLew, Rohner Park, CA (US); Thomas H. Zabatta, Santa Rose, CA (US); Slamet E. Swasono, Rohnert Park, CA (US); Ralph T. Rodriguez, Santa Rosa, CA (US); Isaiah Wilson, Santa Rosa, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/005,059

(22) Filed: Dec. 21, 2007

(51) Int. Cl. H04B 10/20; H04J 14/00

(52) U.S. Cl. 398/58; 398/63

(57) ABSTRACT

A Session Initiation Protocol (SIP) network can malfunction or be incorrectly provisioned in such a way that an Optical Network Terminal (ONT) cannot perform SIP operations and complete SIP voice path calls between the ONT voice port and the SIP network. Accordingly, a technique for validating SIP operations is provided which (i) verifies locally stored SIP operation parameters are currently valid, (ii) initiates an SIP session with a known SIP validation endpoint in an event the locally stored SIP operation parameters are verified to be currently valid, and (iii) reports results of the verifying of the locally stored SIP operation parameters or the initiating of the SIP session. By validating SIP operation parameters, the ONT maintains its state of readiness to support SIP sessions, such as in-coming or outgoing normal or emergency 9-1-1 voice calls.

### BACKGROUND OF THE INVENTION

Session Initiation Protocol (SIP) (Request for Comments (RFC) 3261) is an application-layer control (signaling) protocol for creating, modifying, and terminating sessions with one or more participants. These sessions include Internet telephone calls, multimedia distribution, and multimedia conferences.

SIP invitations, used to create sessions, carry session descriptions that allow participants to agree on a set of compatible media types. SIP makes use of elements called proxy servers to help route requests to the user's current location, authenticate and authorize users for services, implement provider call-routing policies, and provide features to users. SIP also provides a registration function that allows users to upload their current locations for use by proxy servers. SIP runs on top of several different transport protocols.

There are many applications of the Internet that require the creation and management of a session, where a session is considered an exchange of data between an association of participants. The implementation of these applications is complicated by the practices of participants: users may move between endpoints, they may be addressable by multiple names, and they may communicate in several different media-sometimes simultaneously. Numerous protocols have been authored that carry various forms of real-time multimedia session data such as voice, video, or text messages. agents) to discover one another and to agree on a characterization of a session they would like to share. For locating prospective session participants, and for other functions, SIP enables the creation of an infrastructure of network hosts (called proxy servers) to which user agents can send registrations, invitations to sessions, and other requests. SIP is an agile, general-purpose tool for creating, modifying, and terminating sessions that works independently of underlying transport protocols and without dependency on the type of session that is being established.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. SIP transparently supports name mapping and redirection services, which supports personal mobility to allow users to maintain a single externally visible identifier regardless of their network location.

SIP is a component that can be used with other IETF protocols to build a complete multimedia architecture. Typically, these architectures include protocols, such as the Real-time Transport Protocol (RTP) (RFC 1889), for transporting real-time data and providing Quality of Service (QoS) feedback, the Real-Time streaming protocol (RTSP) (RFC 2326) for controlling delivery of streaming media, the Media Gateway Control Protocol (MEGACO) (RFC 3015) for controlling gateways to the Public Switched Telephone Network (PSTN), and the Session Description Protocol (SDP) (RFC 2327) for describing multimedia sessions. Therefore, SIP should be used in conjunction with other protocols in order to provide complete services to the users. However, the basic functionality and operation of SIP does not depend on any of these protocols.

### SUMMARY OF THE INVENTION

An example embodiment of the present technique may be implemented in the form of a method or corresponding apparatus which validates Session Initiation Protocol (SIP) operations. The method and corresponding apparatus according to one example embodiment of the present technique includes: (i) verifying locally stored SIP operation parameters are currently valid, (ii) initiating an SIP session with a known SIP validation endpoint in an event the locally stored SIP operation parameters are verified to be currently valid, and (iii) reporting results of the verifying of the locally stored SIP operation parameters or the initiating of the SIP session

### BRIEF DESCRIPTION OF THE DRAWINGS

The foregoing will be apparent from the following more particular description of example embodiments of the technique, as illustrated in the accompanying drawings in which like reference characters refer to the same parts throughout the different views. The drawings are not necessarily to scale, emphasis instead being placed upon illustrating embodiments of the present technique.

FIG. 1 is a network diagram of an example service provider network in which embodiments of the present technique may be employed;

FIG. 2 is a block diagram of validating Session Initiated Protocol (SIP) operations at a managing network element, in accordance with an example embodiment of the present technique;

FIG. 3 is a block diagram of validating Session Initiated Protocol (SIP) operations at an Optical Network Terminal (ONT), in accordance with an example embodiment of the present technique;

FIG. 4 is a flow chart of an example procedure for validating Session Initiated Protocol (SIP) operations, in accordance with an embodiment of the present technique; and

FIG. 5 is a block diagram of an example apparatus to validate Session Initiated Protocol (SIP) operations, in accordance with an example embodiment of the present technique.

### DETAILED DESCRIPTION OF THE INVENTION

A description of example embodiments of the invention follows.

The Session Initiation Protocol (SIP) works in concert with several other protocols and is only involved in the signaling portion of a communication session. SIP acts as a carrier for the Session Description Protocol (SDP), which describes media content of the communication session, e.g., what Internet Protocol (IP) port to use, the codec being used, etc. As used herein, a SIP session refers to both SIP signaling and a packet stream delivering audio and video over the Internet using a protocol providing end-to-end network transport functions, such as the Real-time Transport Protocol (RTP).

For SIP operations, SIP makes use of service-supporting network elements called proxy servers to help route requests to a user's current location, authenticate and authorize users for services, implement provider call-routing policies, and provide features to users. Another service-supporting network element is a registrar which provides a registration function allowing users to upload their current locations for use by the proxy servers. Other service-supporting network elements include, for example, a Dynamic Host Configuration Protocol (DHCP) server for passing configuration information to hosts or end-nodes on an IP network and a Domain Name System (DNS) for translating human-friendly hostnames into network addresses. As such, to provide SIP operations, parameters relating to these and other service-supporting network elements, as well as SIP users agents (end-points), hereinafter referred to as SIP operating parameters, need to be valid.

A SIP network can malfunction or be incorrectly provisioned in such a way that an optical network terminal (ONT) lacks the ability to complete SIP voice path calls between the ONT voice port and the SIP network. This can make it impossible for the ONT to complete voice calls using SIP.

Using existing error detection techniques, such as those described in various Passive Optical Network (PON) protocols, the foregoing type of ONT or SIP network malfunction may not be detected or, if detected (e.g., by a complete system failure), may not be identified.

One known technique involves using low-level Element Management System (EMS) or Optical Line Terminal (OLT) commands to inspect the state of various parameters, which cannot be viewed at an ONT currently. However, with this technique, certain EMS or operator errors regarding SIP operation parameters go undetected or may be detected only via a total communications failure. Similarly, certain ONT malfunctions go undetected or may be detected only via a total communications failure. Unfortunately, using low-level EMS or OLT commands to inspect the state of various parameters results in less timely and more costly correction of errors relating to SIP operation parameters, and, consequently, increases customer down time.

Accordingly, one aspect of the present technique is to at least enable field technicians (or users) to detect an error condition while in the field at an ONT installation site and to identify proper corrective measures to complete ONT-to-OLT provisioning with respect to SIP. In some instances, the present technique may be implemented by modifying the EMS and/or the ONT with the capability for detecting errors relating to SIP operation parameters. As such, in these instances, errors relating to SIP operation parameters may be detected without additional test equipment.

In one example embodiment, at an Element Management System (EMS), from an EMS status window opened for a subject Optical Network Terminal (ONT), the states of the following Session Initiation Protocol (SIP) operation parameters are verified to have changed from their default inactive states: (i) Dynamic Host Configuration Protocol (DHCP) is enabled, (ii) SIP state machine is configured, and (iii) SIP alarms are not active for: (a) DHCP, (b) user device configuration, (c) SIP application configuration, and (d) SIP user configuration. Additionally, the following SIP operation parameters are verified to have non-zero values: (i) Internet Protocol (IP) address, (ii) IP subnet mask, (iii) IP gateway, (iv) Domain Name System (DNS) server, (v) DHCP client identifier, (vi) SIP domain name, (vii) configuration server proxy IP address, (viii) configuration server proxy IP port number, and (ix) SIP registration state. It should be understood that the foregoing lists are examples; other embodiments or applications may have more, fewer, or different members of the lists.

In another example embodiment, at an Optical Network Terminal (ONT), from an ONT Ethernet port, using a personal computer (PC) or other user device running a telnet session to the ONT, an operator enters a debug command (e.g., “sip operation status”) to verify that the states of the following SIP operation parameters, for example, have changed from their default inactive states: (i) Dynamic Host Configuration Protocol (DHCP) is enabled, (ii) SIP state machine is configured, and (iii) SIP alarms are not active for: (a) DHCP, (b) user device configuration, (c) SIP application configuration, and (d) SIP user configuration. Additionally, the following SIP operation parameters are verified to have non-zero values: (i) Internet Protocol (IP) address, (ii) IP subnet mask, (iii) IP gateway, (iv) Domain Name System (DNS) server, (v) DHCP client identifier, (vi) SIP domain name, (vii) configuration server proxy IP address, (viii) configuration server proxy IP port number, and (ix) SIP registration state.

Results of the verifying or test status are communicated or otherwise reported to the operator through the ONT Ethernet port via the telnet session running on the PC. The results reported may include, for example, error type and which SIP operation parameters are valid and which are invalid. The results of the verifying may also be reported in an ONT Management Control Interface (OMCI) message sent from the ONT to an EMS network control center.

In yet another example embodiment, at an Optical Network Terminal (ONT), from an ONT phone port and using a telephone handset (e.g., a Dual-Tone Multi-Frequency (DTMF) or TOUCHTONE phone), an operator can enter a special phone number, such as 999-999-8888 that is otherwise unused in normal operation, to request the ONT to verify that the states of the following example SIP operation parameters have changed from their default inactive states: (i) Dynamic Host Configuration Protocol (DHCP) is enabled, (ii) SIP state machine is configured, and (iii) SIP alarms are not active for: (a) DHCP, (b) user device configuration, (c) SIP application configuration, and (d) SIP user configuration. Additionally, the following SIP operation parameters are verified to have non-zero values: (i) Internet Protocol (IP) address, (ii) IP subnet mask, (iii) IP gateway, (iv) Domain Name System (DNS) server, (v) DHCP client identifier, (vi) SIP domain name, (vii) configuration server proxy IP address, (viii) configuration server proxy IP port number, and (ix) SIP registration state. Again, the foregoing lists are examples for the purpose of illustration.

Using an indicator, such as one or more light-emitting diodes (LEDs) on the ONT, results of the verifying or test status may be communicated or otherwise reported to the operator, for example, by the number of flashes of the LEDs. The results reported may include, for example, error type and which SIP operation parameters are valid and which are invalid. Alternatively (or additionally), the results of the verifying may be reported to the operator as a prerecorded message played back through the phone port on the ONT. The prerecorded message may further explain an error in ONT to OLT provisioning with respect to SIP and provide proper corrective measures. The results of the verifying may also be reported in an ONT Management Control Interface (OMCI) message sent from the ONT to an EMS network control center.

One of ordinary skill in the art will readily recognize that example embodiments of the present invention are not limited to verifying the states of the foregoing SIP operation parameters, but may include other SIP operation parameters. Moreover, what particular SIP operation parameters and what number of SIP operation parameters are verified may be determined or otherwise dictated by, for example, SIP user agents (end-points) and the SIP network itself.

For example, a SIP network providing more functionality to SIP user agents may involve more SIP operation parameters for SIP operation than a SIP network providing less functionality. As such, the present technique may verify more SIP operation parameters in cases of validating SIP operations of the SIP network providing more functionality.

To validate SIP operations in accordance with example embodiments of the present invention, messaging or signaling between various network elements may be involved. Generally speaking, messaging may include an exchange of management messages, i.e., messages related to managing managed network elements, and non-management messages, such as messages related to setting up a communication session or relating to the communication session itself.

Management messages may be solicitation-driven in nature, e.g., a request message or query prompts a response or reply message. Other management messages may not be sent in response to a request message or otherwise requested, but may be sent, for example, in response to an event occurring, such as a timer expiring.

In an example embodiment, the present approach may verify SIP operation parameters as described previously in response to a request message and report the results of the verifying with a response message. In another embodiment, the present approach may verify SIP operation parameters in response to an event occurring, such as an operator entering a debug command.

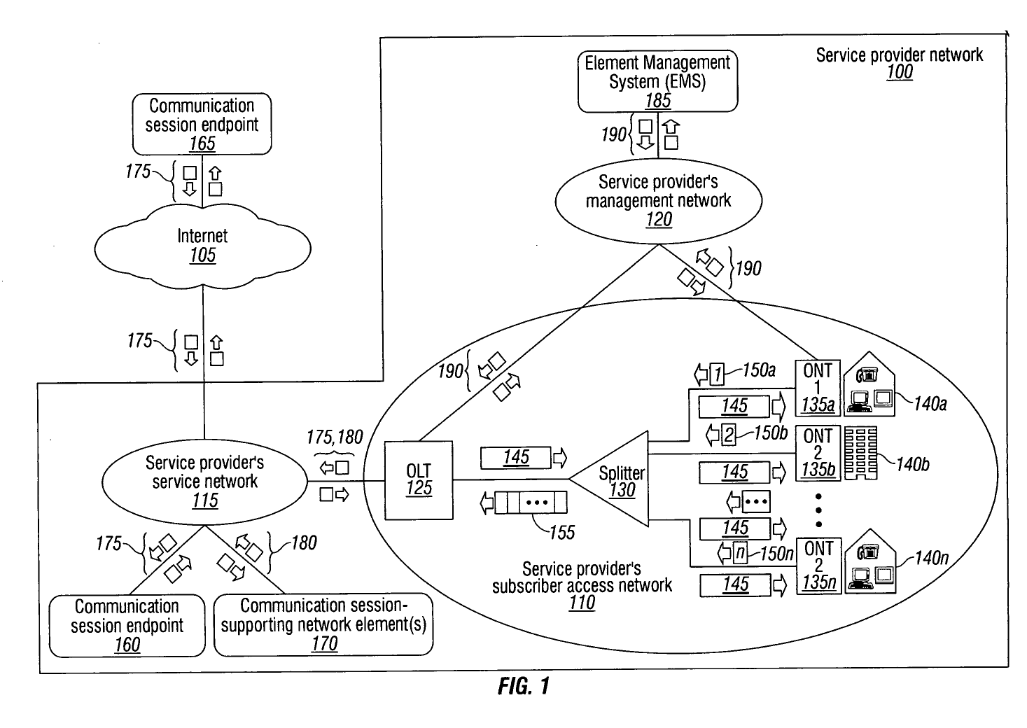

FIG. 1 illustrates an example service provider network 100 in which example embodiments of the present technique may be employed. The example service provider network 100 is internetworked or otherwise in communication with the Internet 105. The service provider network 100 may be divided by function into a subscriber access network 110, a service network 115, and a management network 120.

The subscriber access network 110 provides subscribers access to the service provider network 100 and the Internet 105 at least at the physical and the data link layers of the Open Systems Interconnection Basic Reference Model or “OSI reference model.” The service network 115 connects subscribers to the service provider network 100 in the Internet 105 at least at the network layer of the OSI reference model. The service network 115 further provides subscribers with local services, that is, services within the service provider network 100. The management network 120 manages the service provider network 100 and its network elements.

It should be readily apparent to one of ordinary skill in the art that the foregoing networks are purely logical and may take on any physical manifestation.

The subscriber access network 110 illustrated in FIG. 1 is a passive optical network (PON) having an optical line terminal (OLT) 125 connected via a splitter 130 to optical network terminals (ONTs) 135a . . . n. The ONTs 135a . . . n serve subscribers 140a . . . n, providing them access to the service provider network 100 and the Internet 105.

Downstream communications 145 from the service provider network 100 and the Internet 105 are broadcast to the ONTs 135a . . . n and finally to the subscribers 140a . . . n. Upstream communications 150a . . . n from the subscribers 140a . . . n are sent to the service provider network 100 and the Internet 105 using a multiple access method, such as time division multiple access (TDMA), resulting in multiplexed upstream communications 155.

One of ordinary skill in the art will readily recognize that the subscriber access network 110 being a PON is merely for illustrative purposes and includes other such networks as asynchronous transfer mode passive optical network (APON), Ethernet passive optical network (EPON), gigabit passive optical network (GPON), and other PON variants. Additionally, the subscriber access network 110 may use other access technologies, such as modem dial-up, digital subscriber line (DSL), and cable modem.

The service network 115 having connected the subscribers 150a . . . n to the service provider network 100 and the Internet 105 provides local and remote services, such as data, voice, and video to the subscribers 150a . . . n. Both local and remote services are provided through communication sessions.

In the case of local service, there is a communication sessions between the subscriber 140a and a communication session endpoint which is internal to the service provider network 100 and herein referred to as an “internal” communication session endpoint 160. In the case of remote service, there is a communication session between the subscriber 140a and a communication session endpoint, which is external from the service provider network 100, located somewhere in the Internet 105, and herein referred to as an “external” communication session endpoint 165.

The intended meaning of the phrase “communication session” is a period during which data, voice, and/or video are communicated or otherwise exchanged. The use of the phrase “communication session,” however, is not intended to imply a particular application protocol (such as Hypertext Transfer Protocol (HTTP) for web pages and Real-time Transport Protocol (RTP) for voice and video), a particular transport protocol (such as Transmission Control Protocol (TCP) for connection-based transport or User Datagram Protocol (UDP) for connectionless transport), a particular network protocol, such as Internet Protocol (IP), a particular mode or method of communication (such as broadcasting for one-to-all communication, multicasting for one-to-many communication, and unicasting for one-to-one communication), or a particular direction of communication (i.e., bidirectional or unidirectional). Communication sessions are illustrated in FIG. 1 as communication session signals or messages 175.

Establishing or otherwise initiating a communication session may involve support from one or more communication session-supporting network elements 170. Example communication session-supporting network elements include, but are not limited to, a Dynamic Host Configuration Protocol (DHCP) server for passing configuration information to the subscribers 140a . . . n, a Domain Name System (DNS) server for translating human-friendly hostnames into network addresses, and a Session Initiated Protocol (SIP) registrar for providing registration function allowing the subscribers 140a . . . n to upload their current locations. Communications supporting communication sessions are illustrated in FIG. 1 as communication session-supporting signals or messages 180.

Network management tasks fitting into the categories fault, configuration, accounting (or administrations), performance, and security may be performed in part or in whole by a managing network element, such as an element management system (EMS) 185. Communications for managing network elements, such as the OLT 125 and the ONTs 135a . . . n, are illustrated in FIG. 1 as management signals or messages 190.

The aforementioned signals or messages 175, 180, and 190 are illustrated as blocks purely for the purpose of illustration and in no way intended to imply a particular signaling or messaging format or protocol. The aforementioned signals or messages 175, 180, and 190 may be communicated over circuit-switched networks, such as a plain old telephone system (POTS), and packet-based networks, such as an IP network, alike.

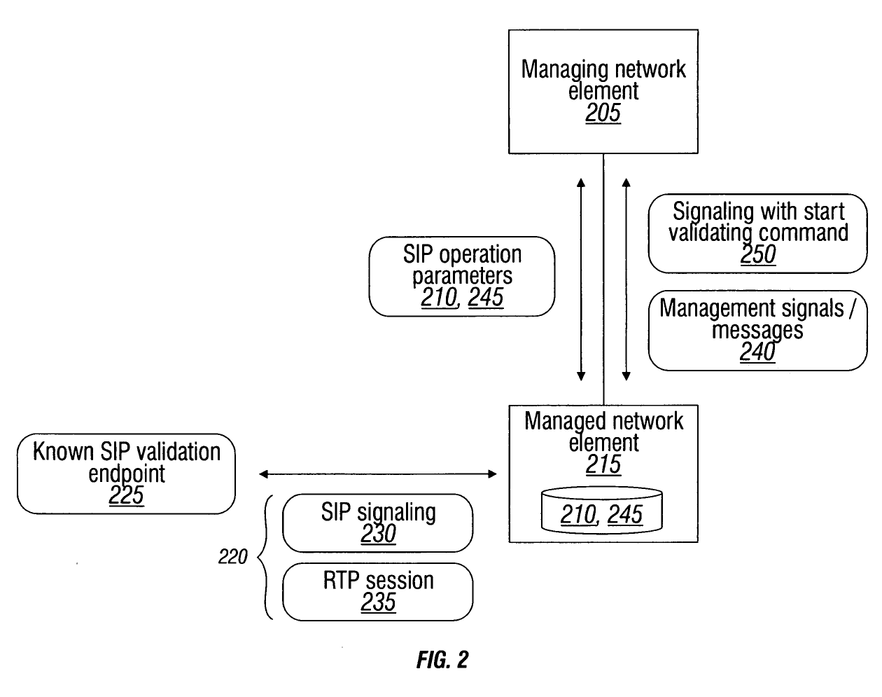

FIG. 2 illustrates validating SIP operations at a managing network element 205 in accordance with an example embodiment of the present technique. In this example, at the managing network element 205, such as the element management system (EMS) 185 of FIG. 1, the present technique verifies locally stored SIP operation parameters 210 are currently valid as described previously. The locally stored SIP operation parameters 210 are stored on a managed network element 215, such as the optical line terminal (OLT) 125 or the optical network terminals (ONTs) 135a . . . n both of FIG. 1.

In an event the locally stored SIP operation parameters 210 are verified to be currently valid, the present technique initiates a SIP session 220 with a known SIP validation endpoint 225, such as the internal communication session endpoint 160 and external communication session endpoint 165 of FIG. 1.

Recall, an internal communication session endpoint is inside a service provider's network (e.g., the service provider network 100 of FIG. 1) while an external communication session endpoint is outside of the service provider's network (e.g., the Internet 105 of FIG. 1). As such, if the present technique fails to initiate the SIP session 220 with the known SIP validation endpoint 225 which is internal to a service provider's network, then SIP operations are not valid within the service provider's network. Therefore, an error lies inside of the service provider's network.

Conversely, if the present technique initiates the SIP session 220 with the known SIP validation endpoint 225 which is internal to a service provider's network successfully, but fails to initiate the SIP session 220 with the known SIP validation endpoint 225 which is external from the service provider's network, then SIP operations are valid at least within the service provider's network. In this case, an error lies outside of the service provider's network.

As described previously, the SIP session 220 includes both SIP signaling 230 and a real-time transport protocol (RTP) session 235 or other packet stream delivering audio and video over the Internet.

Having verified the locally stored SIP operation parameters 210 and initiated the SIP session 220, the present technique reports results of the verifying or the initiating as management signals or messages 240. The management signals or messages 240 may cause an indication to occur and, in turn, notify an operator at the managing network element 205 of the results. For example, a failed result causes a monitoring unit or the like to raise an error alarm, such as a color change from green to red on a status screen or monitor, thereby alerting the operator of the failed result.

In an example embodiment, the present technique reports locally via a machine-to-machine or machine-to-human interface to the managing network element 205, the managed network element 215, a service provider, a manufacturer, or an operator. Alternatively, the present technique reports remotely and transmits information to the managing network element 205, the managed network element 215, the service provider, the manufacturer, or the operator.

FIG. 2 further illustrates that, in an event the locally stored SIP operation parameters 210 are currently invalid, the present technique requests SIP operation parameters 245 from the managing network element 205. The present technique installs the requested SIP operation parameters 245. In this way, in this embodiment, SIP operation parameters are made available for SIP operation when locally stored SIP operation parameters are invalid.

In a convenient embodiment of the present technique, the present technique requests the managing network element 205 access to SIP operation parameters of a neighboring managed network element to use for SIP operation. The present technique then retrieves the SIP operation parameters of the neighboring managed network element and provides the SIP operation parameters to the managed network element having currently invalid SIP operation parameters. Similarly, in this way, in this convenient embodiment, SIP operation parameters are made available for SIP operation when locally stored SIP operation parameters are invalid.

In another convenient embodiment, the present technique identifies signaling with a ‘start validating SIP operations’ command 250 received from the managing network element 205. The present technique, in response to receiving the start validating SIP operations command 250, initiates validating SIP operations in the manner described previously. Alternatively, ‘a start validating SIP operations’ command 250 may be identified in the management signals or messages 240 used to report results of the verifying of the locally stored SIP operation parameters 210 and the initiating of the SIP session 220. Examples of the start validating SIP operations command 250 include, but are not limited to, a debug command or a pattern, such as a Dual-Tone Multi-Frequency (DTMF) tone or tones representing a telephone number.

In yet another convenient embodiment of the present technique, having initiated the SIP session 220, the present technique may receive signaling relating to call service from the known SIP validation endpoint 225. The present technique may further determine measures of Quality of Service (QoS) from the received signaling related to call service. The signaling related to call service may be separate from or part of the SIP signaling 230 and the RTP session 235.

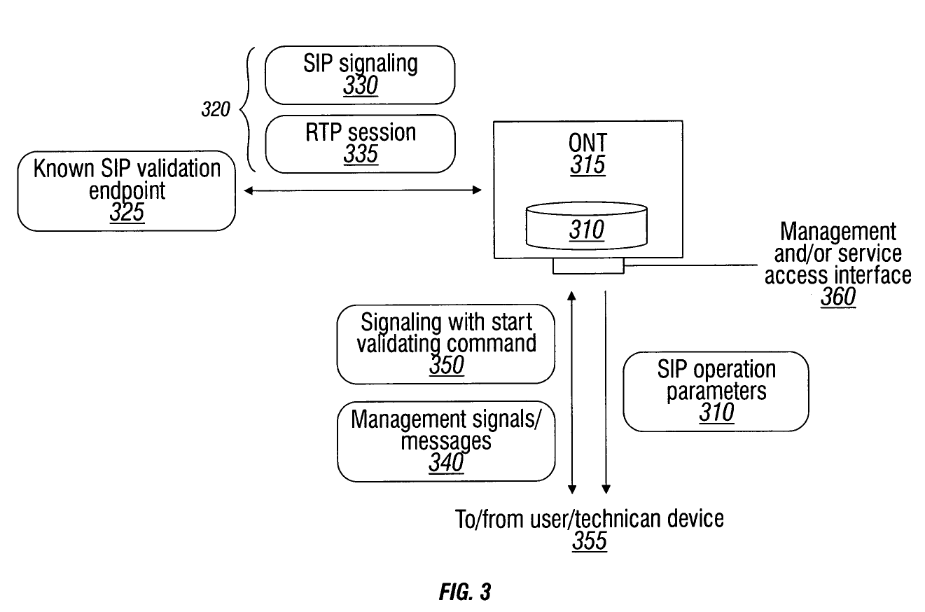

FIG. 3 illustrates validating SIP operations at an optical network terminal (ONT) 315, in accordance with an example embodiment of the present technique. In this example, at the ONT 315, the present technique verifies locally stored SIP operation parameters 310 are currently valid as described previously.

In an event the locally stored SIP operation parameters 310 are verified to be currently valid, the present technique initiates a SIP session 320 with a known SIP validation endpoint 325, such as the internal communication session endpoint 160 and external communication session endpoint 165 of FIG. 1. As described previously, the SIP session 320 includes both SIP signaling 330 and a real-time transport protocol (RTP) session 335 or other packet stream delivering audio and video over the Internet.

Having verified the locally stored SIP operation parameters 310 and initiated the SIP session 320, the present technique reports results of the verifying or the initiating as management signals or messages 340. In the example illustrated in FIG. 3, the present technique reports locally to an operator or technician who is using a user device 355 via a machine-to-machine or machine-to-human interface 360.

The interface 360 may be dedicated to management purposes and communicate only the management signals or messages 340. Alternatively, the interface 360 may be shared between management and service access purposes. In such an alternative, the interface 360 communicates both the SIP session 320 and the management signals or messages 340.

In one convenient embodiment, the user device 355 is a personal computer (PC) or other user device running a telnet session to the ONT 315, and the interface 360 is an Ethernet port on the ONT 315. In this embodiment, the present technique identifies a ‘start validating SIP operations’ command 350, such as a debug command entered using the PC, received by the ONT 315. The present technique, in response to receiving the start validating SIP operations command 350, initiates validating SIP operations in the manner described previously. The start validating SIP operations command 350 is identified in the management signals or messages 340 also used to report results of the verifying of the locally stored SIP operation parameters 310 and the initiating of the SIP session 320.

The result of validating SIP operations is then reported or otherwise communicated back to the operator using the PC. The result reported may include, for example, error type and which SIP operation parameters are valid and which are invalid. The result reported may further explain an error in ONT to OLT provisioning with respect to SIP and provide proper corrective measures.

In another convenient embodiment, the user device 355 is a telephone handset, such as a Dual-Tone Multi-Frequency (DTMF) or TOUCHTONE phone, dialed into the ONT 315, and the interface 360 is a phone port on the ONT 315. In this embodiment, the present technique identifies a start validating SIP operations command 350, such as a special phone number dialed by an operator using the telephone handset, received by the ONT 315. The present technique, in response to receiving the command 350, initiates validating SIP operations in the manner described previously. The start validating SIP operations command 350 is identified in signaling also used to initiate a SIP session.

The result of validating SIP operations is then reported or communicated back to the operator using the telephone handset as prerecorded message. The prerecorded message may further explain an error in ONT to OLT provisioning with respect to SIP and provide proper corrective measures.

In the foregoing convenient embodiments, results of validating SIP operations may be reported to an operator alternatively or additionally using an indicator, such as one or more light-emitting diodes (LEDs) on the ONT 315.

In yet another convenient embodiment of the present technique, having initiated the SIP session 320, the present technique may receive signaling relating to call service from the known SIP validation endpoint 325. The present technique may further determine measures of Quality of Service (QoS) from the received signaling related to call service. The signaling related to call service may be separate from or part of the SIP signaling 330 and the RTP session 335.

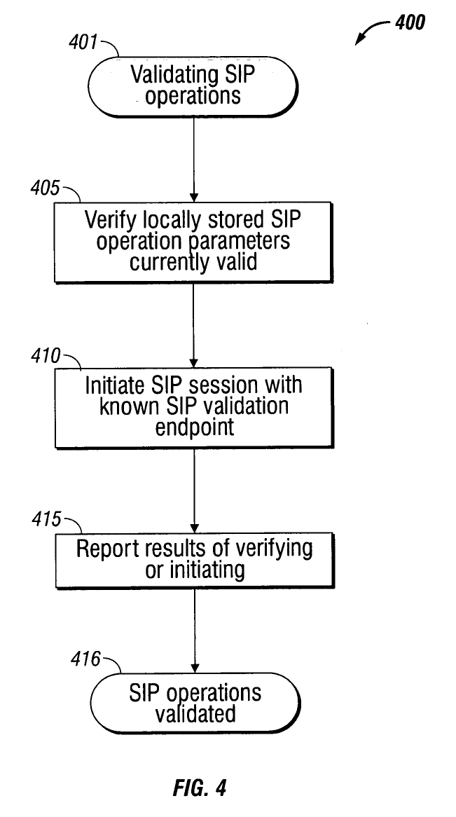

FIG. 4 illustrates an example procedure 400 for validating SIP operations. The example procedure 400 starts (401) validating SIP operations. The example procedure 400 verifies (405) locally stored SIP operation parameters are currently valid. The example procedure 400 initiates (410) an SIP session with a known SIP validation endpoint in an event the locally stored SIP operation parameters are verified to be currently valid. The example procedure 400 reports (415) results of the verifying of the locally stored SIP operation parameters or the initiating of the SIP session. The example procedure 400 ends (416) with SIP operations validated.

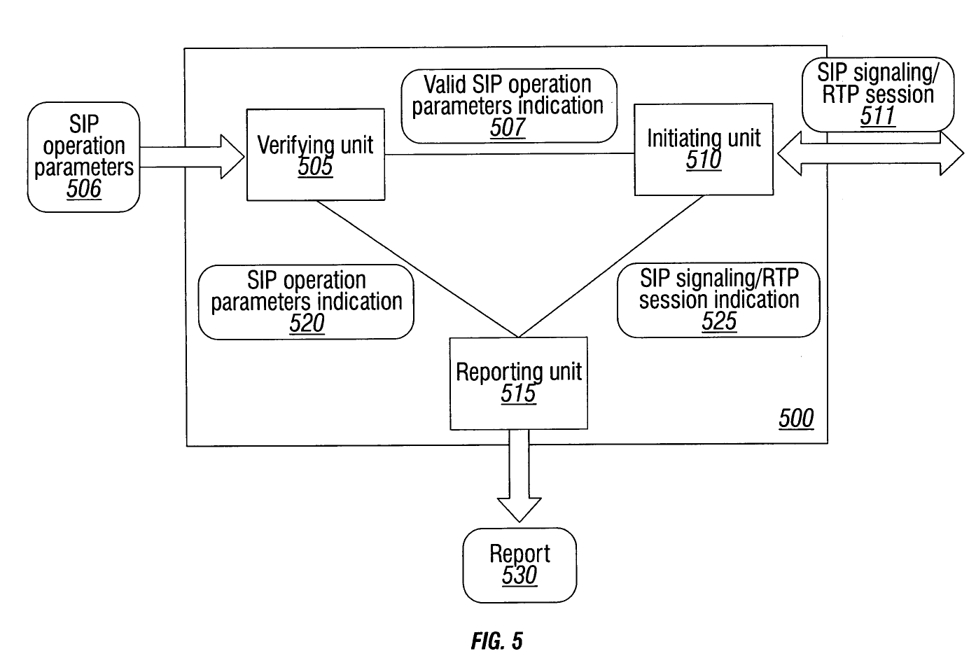

FIG. 5 illustrates an example apparatus 500 to validate Session Initiation Protocol (SIP) operations. The example apparatus 500 includes a verifying unit 505, initiating unit 510, and reporting unit 515. The verifying unit 505 and the initiating unit 510 are communicatively coupled or otherwise in communication with one another. The verifying unit 505 and the initiating unit 510 are further communicatively coupled to the reporting unit 515.

The verifying unit 505 verifies SIP operation parameters 506 are currently valid in the manner described previously. In an event, the SIP operation parameters 506 are currently valid as indicated by a valid SIP operation parameters indication 507, the initiating unit 510 initiates a SIP session 511 in the manner described previously.

A SIP operation parameters indicator 520 indicates a result of the verifying unit 505 verifying the SIP operation parameters 506. A SIP session indicator 525 indicates a result of the initiating unit 510 initiating the SIP session 511. The reporting unit 515 reports the result of the verifying indicated by the SIP operation parameters indicator 520 and the result of the initiating indicated by the SIP session indicator 525 as a report 530.

While this invention has been particularly shown and described with references to example embodiments thereof, it will be understood by those skilled in the art that various changes in form and details may be made therein without departing from the scope of the invention encompassed by the appended claims.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method for validating Session Initiation Protocol (SIP) operations, comprising:
verifying locally stored SIP operation parameters are currently valid;
initiating an SIP session with a known SIP validation endpoint in an event the locally stored SIP operation parameters are verified to be currently valid; and
reporting results of the verifying of the locally stored SIP operation parameters or the initiating of the SIP session.

2. The method of claim 1 further comprising requesting the SIP operation parameters from a managing network element in an event the locally stored SIP operation parameters are currently invalid.

3. The method of claim 2 further comprising installing the SIP operation parameters requested from the managing network element.

4. The method of claim 1 wherein, in a passive optical network (PON), the known SIP validation endpoint is external from a network or service-supporting network element supporting SIP operation for the PON.

5. The method of claim 1 further comprising receiving signals related to call service from the known SIP validation endpoint.

6. The method of claim 5 further including determining a measure of Quality of Service (QoS) based on the signals related to the call service.

7. The method of claim 1 further comprising:
identifying a ‘start validating SIP operations’ command in signaling that is also used to initiate a SIP session; and responsively starting validating SIP operations.

8. The method of claim 7 wherein identifying includes receiving the signaling from a user device.

9. The method of claim 7 wherein identifying includes receiving the signaling from a managing network element.

10. The method of claim 1 further including:
requesting of a managing network element access to SIP operation parameters of a neighboring managed network element to use for SIP operation;
retrieving the SIP operation parameters of the neighboring managed network element; and
providing the SIP operation parameters of the neighboring managed network element to the managed network element having currently invalid SIP operation parameters.

11. The method of claim 1 wherein the reporting includes reporting locally via a machine-to-machine or machine-to-human interface or remotely by transmitting information to a managing network element, managed network element, service provider, manufacturer, or craft person.

12. A apparatus to validate Session Initiation Protocol (SIP) operations, comprising:
a verifying unit to verify locally stored SIP operation parameters are currently valid;
an initiating unit communicatively coupled to the verifying unit to initiate an SIP session with a known SIP validation endpoint in an event the locally stored SIP operation parameters are verified to be currently valid; and
a reporting unit communicatively coupled to the verifying unit and the initiating unit to report results of the verifying unit's verifying the locally stored SIP operation parameters or the initiating unit's initiating the SIP session.

13. The apparatus of claim 12 further comprising a requesting unit communicatively coupled to the verifying unit to request the SIP operation parameters from a managing network element in an event the locally stored SIP operation parameters are currently invalid.

14. The apparatus of claim 13 further comprising an installing unit communicatively coupled to the requesting unit to install the SIP operation parameters requested from the managing network element.

15. The apparatus of claim 12 wherein, in a passive optical network (PON), the known SIP validation endpoint is external from a network or service-supporting network element supporting SIP operation for the PON.

16. The apparatus of claim 12 further comprising a receiving unit communicatively coupled to the initiating unit to receive signals related to call service from the known SIP validation endpoint.

17. The apparatus of claim 16 further including a determining unit communicatively coupled to the receiving unit to determine a measure of Quality of Service (QoS) parameters based on the signals related to the call service.

18. The apparatus of claim 1 further comprising:
an identifying unit communicatively coupled to the verifying unit to identify a ‘start validating SIP operations’ command in signaling that is also used to initiate a SIP session and to responsively start validating SIP operations.

19. The apparatus of claim 18 wherein the identifying unit is configured to receive the signaling from a user device.

20. The apparatus of claim 18 wherein the identifying unit is configured to receive the signaling from a managing network element.

21. The apparatus of claim 12 further including:
a requesting unit communicatively coupled to the verifying unit to request of a managing network element access to SIP operation parameters of a neighboring managed network element to use for SIP operation;
a retrieving unit communicatively coupled to the requesting unit to retrieve the SIP operation parameters of the neighboring managed network element; and
a providing unit communicatively coupled to the retrieving unit to provide the SIP operation parameters of the neighboring managed network element to the managed network element having currently invalid SIP operation parameters.

22. The apparatus of claim 12 wherein the reporting unit includes a machine-to-machine or machine-to-human interface to report locally or to report remotely by transmitting information to a managing network element, non-managing network element, service provider, manufacturer, or operator.

23. A computer program product comprising a computer readable medium having a computer readable program, wherein the computer readable program, when executed by a processor, causes the processor to:
verify locally stored SIP operation parameters are currently valid;
initiate an SIP session with a known SIP validation endpoint in an event the locally stored SIP operation parameters are verified to be currently valid; and
report results of the verifying of the locally stored SIP operation parameters or the initiating of the SIP session.
